(19) United States
(12) Patent Application Publication
(10) Pub. No.: US 2022/0053976 A1
(43) Pub. Date: Feb. 24, 2022

(54) Magnetic Fabric Toaster Cover

(71) Applicant: Madelyn Banks, Calumet Park, IL (US)

(72) Inventor: Madelyn Banks, Calumet Park, IL (US)

(21) Appl. No.: 16/998,969

(22) Filed: Aug. 20, 2020

(51) Int. Cl. A47J 37/08

(52) U.S. Cl. CPC A47J 37/0871

(57) ABSTRACT

The magnetic toaster cover adheres to the sides of most metal and stainless-steel toasters. It only covers the open toaster slots and hangs approximately 2 inches on the right and left sides of a toaster. It will not fall off, but can be repeatedly and easily removed and placed back on the toaster once it cools off as needed.

### BRIEF DESCRIPTION OF DRAWINGS

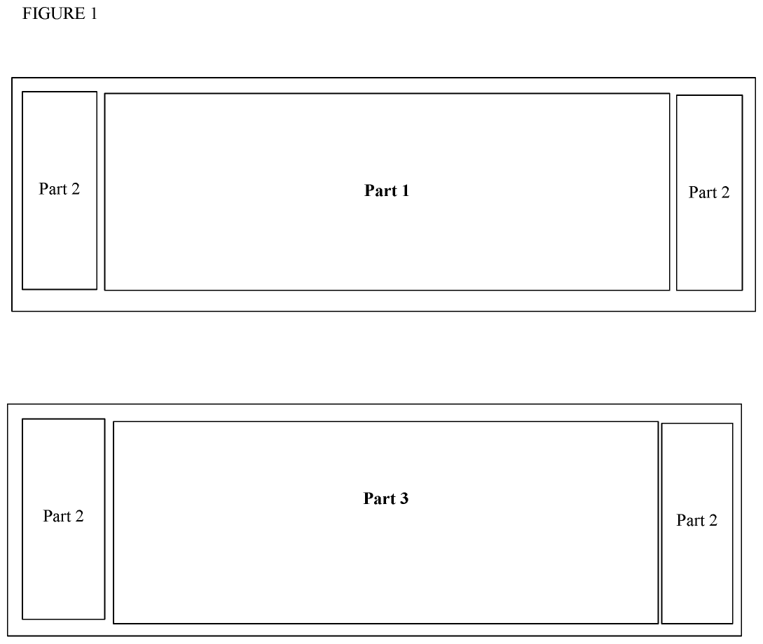

1. Drawing 1—FIG. 1 depicts 3 parts of the Magnetic Fabric Toaster Cover.
a. Part 1 is the fabric front and the side that lays upward and faces the upward
b. Part 2 is the fabric back and the side that lays downward toward the toaster slots
c. Part 3 are the 2 flat flexible magnets sewed within the fabric.

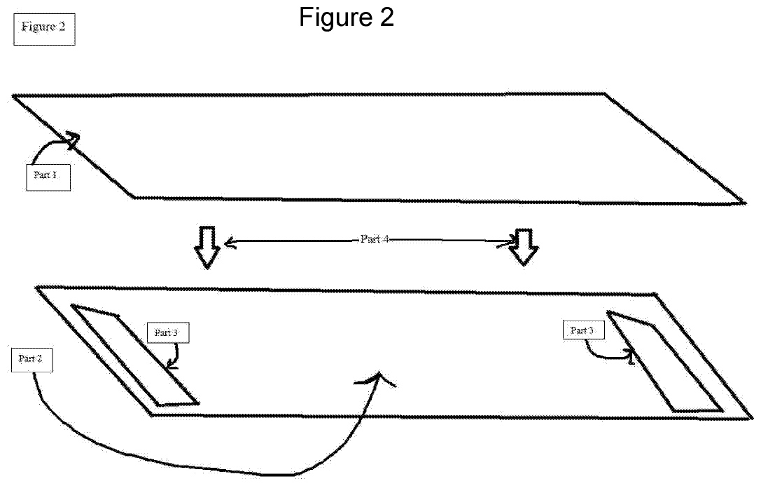

2. Drawing 2—FIG. 2 depict the 3 parts and the action taken with those parts of the Magnetic Fabric Toaster Cover.
a. Part 1 is rectangular cut fabric and is the top or the side facing upward
b. Part 2 is rectangular cut fabric and is the bottom or the side that lies downward against the toaster
c. Part 3 are the flexible industrial magnets placed on each side of the fabric
d. Part 4 is the placing together of Part 1, Part 2, and Part 3 by sewing the parts together, and placing the magnets between the top and bottom of the fabric.

### DETAILED DESCRIPTION OF THE MAGNETIC FABRIC TOASTER COVER

### How it is Made

This item is made with fabric that is 100% cotton. The weight of the fabric varies from lightweight cotton at 3 ounces to heavier upholstery cotton at 7 ounces. Occasionally upholstery cotton is used up to 10 ounces.

The next component used are industrial flexible magnets. These magnets are 1 inch wide and 6 inches long and may be longer depending on the size of the toaster.

The final item used is thread, usually quilting thread which is most often 100 percent cotton.

The completed Magnetic Fabric Toaster Cover item is usually 13 inches wide and 7.5 inches long for 2 slice toasters and 18 inches wide and 7.5 inches long for 4 slice toasters. For long slot toasters the measurements are usually 12inches wide and 12 inches long.

A sewing machine is used to make this product. It is initially stitched with the material outside facing inward. An opening is left in the fabric when sewing, so that the item can be turned inside out after the initial stitching. Once the initial stitching is completed the edges are cut and trimmed and the fabric is reversed so that the inside is now facing outside. The industrial flexible magnets are inserted and the product is ironed.

The next step is to stitch ¼ inch around the perimeter with decorative stitching. The next step is to iron again to flatten the magnet and make sure it is in place before final stitching. The magnet is positioned, one on the left and the other on the right sides of the toaster cover. Then it is stitched again 2 inches from the far left and right sides of the toaster cover which is the width measurement.

### What Makes This Toaster Cover Different?

1. First and foremost, this toaster cover is magnetic. Once it is placed on the toaster it will not fall off.
2. It does not cover the entire toaster, but only the open toaster slots and sides. This has proven to be of value to those who want to keep their toaster clean, but also display the item. The toaster slots are where dust, fruit flies, germs, and other floating particles can fall into the open toaster slots and be cooked with the toast.
3. It is modern and has a clean defined look. It is not the cumbersome bulky toaster covers that cover the entire toasters.
4. The magnetic toaster cover allows its owners to still admire their high-end toaster and it also complement their overall kitchen decor.
5. To date, there are no other toaster covers on the market with this unique compilation of material and magnets specifically designed for counter top toasters.

### BACKGROUND OF THE INVENTION

The magnetic fabric toaster cover idea came about because I wanted to cover my brand-new stainless-steel toaster, but not completely. I only wanted to protect the top of the toaster to ensure dust and germs did not float into it, but still display the exterior of the toaster. I loved how my toaster looked and wanted something to compliment, not hide it as traditional toaster covers do. This idea intrigued me so much, I learned how to sew in order to make it.

As a germaphobe, I imagined the dust particles, dust mites, small spiders, bugs, and floating particles left to float or fall into my uncovered kitchen counter toaster. My solution not only keep the germs away, but add 3 to the overall kitchen dėcor.

I research the materials needed to make this idea come to fruition. This brought me to the crux of my invention, the application of flexible magnets. I took commonly used items, cotton fabric, cotton thread and a very thin flexible magnet with 8 lb holding power to create the magnetic fabric toaster cover. It will hug the sides of most metal and stainless-steel toasters.

### BRIEF SUMMARY OF THE INVENTION

### Magnet Fabric Toaster Cover

This item is used as a toaster cover to cover the top open slots of toasters. It has on the left and right sides a fabric covered flexible magnet, which allows the toaster cover to adhere (hug) to the sides of metal toasters with magnetic properties.

This allows for the cover to stay on and not slip off, but is also easily removeable. The entire item can be wash in cold water with like colors and dried on a low temperature.

It does not fit over the entire toaster, but only the top open area of a toaster. It is wide enough to hang over the edge of the width of the toaster and hangs approximately 2.5 inches on each side (depending on the size of the toaster). It is positioned this way because the goal is to keep dust, germs, fruit flies, bugs and other small items from falling into the toaster, and also to not cover the entire toaster, but to allow consumers to display their toaster.

The Magnetic Toaster Cover is its ability to adhere to the sides of an electric toaster and not fall off using a magnet sewn into or onto fabric

1. I am making claim to the process of using any type of flexible magnet sewn inside any fabric or other mass that resembles the end product of the magnetic toaster cover.

2. I am making a claim to any item which would replace covering only the top and/or sides of a 2, 4 or long slot toaster or any similar toaster item.
